(19) United States
(12) Patent Application Publication
(10) Pub. No.: US 2025/0103720 A1
(43) Pub. Date: Mar. 27, 2025

(54) POST-QUANTUM CRYPTOGRAPHY RISK MODELING

(71) Applicant: Wells Fargo Bank, N.A., San Francisco, CA (US)

(72) Inventors: Peter Bordow, Fountain Hills, AZ (US); Thomas Gilheany, San Francisco, CA (US); Shannon B. Hill, Greensboro, NC (US); Dale C. Miller, San Francisco, CA (US); Charlee Alexandra Stefanski, San Francisco, CA (US); Richard Orlando Toohey, Burlington, VT (US)

(21) Appl. No.: 17/805,577

(22) Filed: Jun. 6, 2022

Related U.S. Application Data
(60) Provisional application No. 63/264,116, filed on Nov. 16, 2021.

(51) Int. Cl. G06F 21/57; G06Q 10/0635

(52) U.S. Cl. CPC G06F 21/577; G06Q 10/0635; G06F 2221/033

(57) ABSTRACT

An example system for modeling of risk associated with post-quantum cryptography can include: at least one processor; and memory encoding instructions that, when executed by the at least one processor, cause the system to: identify a plurality of applications associated with an entity; define one or more cryptographies associated with each of the plurality of applications; select an estimated time at which the one or more cryptographies will be compromised by the post-quantum cryptography; and estimate a cost of remediation for one or more of the plurality of applications.

### BACKGROUND

Assessing and quantifying cryptographic risks are difficult tasks. The threat of Cryptographic Relevant Quantum Computers (CRQCs) is significant, but the timeline for when this will occur is murky at best.

### SUMMARY

The present disclosure relates to post-quantum cryptography risk modeling.

In one aspect, an example system for modeling of risk associated with post-quantum cryptography can include: at least one processor; and memory encoding instructions that, when executed by the at least one processor, cause the system to: identify a plurality of applications associated with an entity; define one or more cryptographies associated with each of the plurality of applications; select an estimated time at which the one or more cryptographies will be compromised by the post-quantum cryptography; and estimate a cost of remediation for one or more of the plurality of applications.

### DESCRIPTION OF THE DRAWINGS

FIG. 1 shows an example system for performing post-quantum cryptography risk modeling.

FIG. 2 shows an example risk framework associated with the system of FIG. 1.

FIG. 3 shows an example scenario estimating a probability of Cryptographic Relevant Quantum Computers (CRQCs) being developed.

FIG. 4 shows another example scenario estimating a probability of CRQCs being developed.

FIG. 5 shows data flow for an example application associated with the system of FIG. 1.

FIG. 6 shows an example network graph illustrating a risk model produced for the system of FIG. 1.

FIG. 7 shows another network graph illustrating a risk model produced for the system of FIG. 1.

FIG. 8 shows other network graphs illustrating risk models produced for the system of FIG. 1.

### DETAILED DESCRIPTION

The present disclosure relates to post-quantum cryptography risk modeling.

In the examples provided herein, various modeling is provided that assesses the potential risks posed by Cryptographic Relevant Quantum Computers (CRQCs). In these examples, an entity can use the risk modeling on various applications associated with the entity.

For instance, the risk modeling provided herein can be used by the entity to answer various questions associated with CRQCs. Examples of such questions include, without limitation, the following.

What is the cheapest remediation method for the riskiest device associated with the entity's application XXX?

What is my riskiest application in the entity?

Which applications do I not need to worry about in the entity?

What is my most valuable remediation for the entity (e.g., biggest effect at lowest cost)?

In the examples provided herein, the entity is a financial institution. However, the risk modeling described herein is equally applicable to any type of entity.

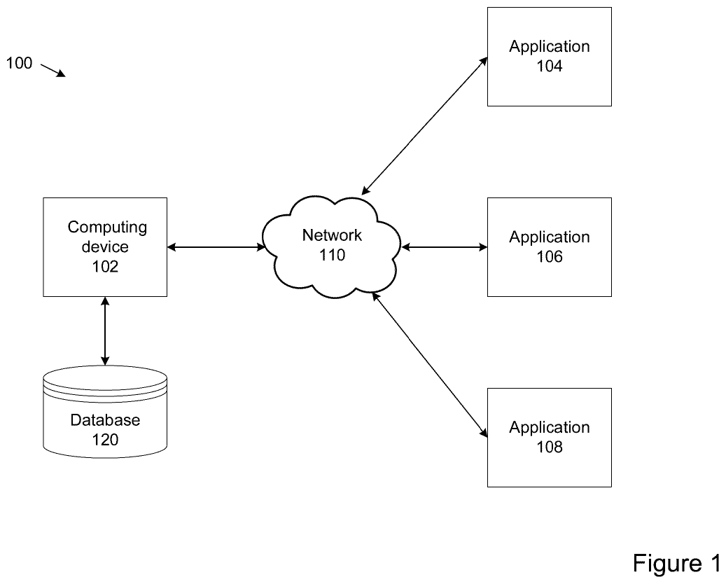

Referring now to FIG. 1, an example system 100 associated with the entity is shown. In this example, the system 100 can constitute the entire entity or a portion of the entity.

The example system 100 includes a computing device 102, applications 104, 106, 108, and a database 120. While a single computing device and three applications are shown in this example, in reality there can be hundreds, thousands, or millions of computing devices and applications.

In this example, the computing device 102 is programmed to perform post-quantum cryptography risk modeling. For instance, the computing device 102 executes the various risk modeling that is provided herein to analyze the impact of CRQCs on the applications 104, 106, 108 of the system 100. The computing device 102 can be programmed to query the database 120 to obtain the data necessary for modeling, such as remediation information, etc.

The computing device 102 communicates with the applications 104, 106, 108 through a network 110. In this example, the network 110 can be any type of wired and/or wireless network, including a local area network, a wide area network, or the Internet.

In this example, the applications 104, 106, 108 are various applications used by the entity to conduct business. These applications 104, 106, 108 can include data that has a financial impact on the entity. Such data can be associated with a product, customers, etc. Applications 104, 106, 108 can each have an annual financial impact score and a shelf life for how long that data is stored, as described further below.

There can be various advantages and practical applications associated with the system 100 and the risk modeling provided by the computing device 102. For example, the development of CRQCs poses a serious technical risk to the applications of an entity. The modeling described herein provides the practical application of allowing that risk to be quantified. By doing so, the technical risks associated with CRQCs can be mitigated more efficiently. Many other technical advantages are possible.

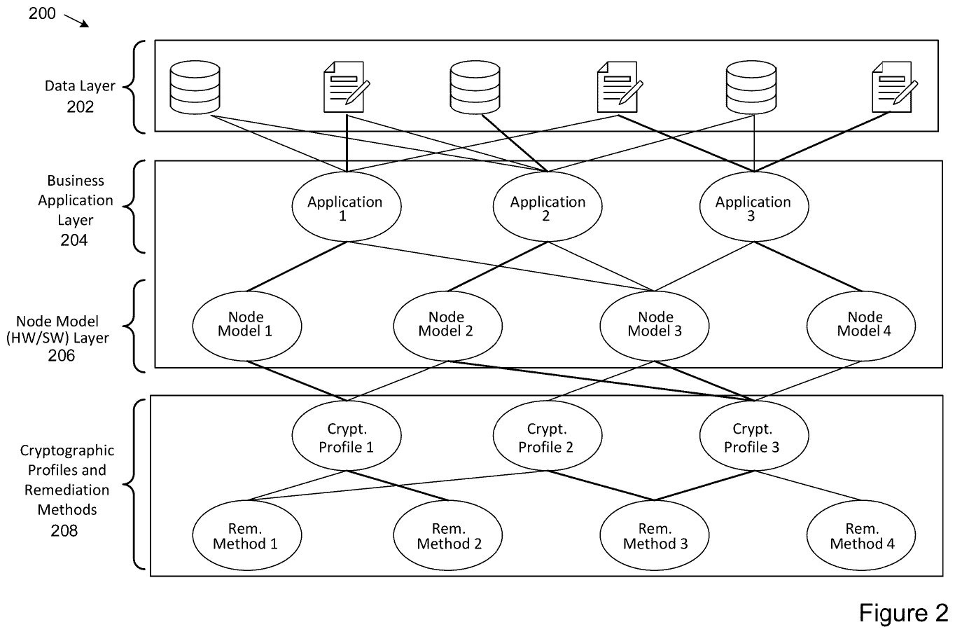

Referring now to FIG. 2, an example risk framework 200 is shown. This framework 200 depicts data 202 used for critical operations across the entity with varying shelf life. That data 202 is manipulated through a business application layer 204, such as by the applications 104, 106, 108.

In addition to the applications layer 204, a node layer 206 includes points in the network 110 through which applications pass data. These nodes of the node layer 206 can be a server, router, encryptor, firewall, etc. In these examples, the risk modeling performed by the computing device 102 is done at the node model level.

Bad actors may target infrastructure, as represented by the node layer 206, that touches valuable data. The risk modeling described herein allows for the prioritization of remediation actions around the application layer 204 and node layer 206.

More specifically, each of the nodes in the node layer 206 can have one or more a cryptographic profiles and potential remediation options, as depicted in a cryptographic profile and remediation layer 208.

This cryptographic profile provides details of the cryptography used by a node. Each cryptographic method has a series of possible remediations to become resilient to CRQCs. Details of the remediation for the relevant current cryptography can include such options as a Post Quantum Computer (PQC) algorithm, larger key size, etc.

Each remediation has an associated cost. This cost is the estimated implementation time in years. A quantum-day (Q-Day), represented by tn, is the estimated time, in years, for development of CRQCs.

There can be a few different scenarios to consider when looking at the probability of CRQCs being developed.

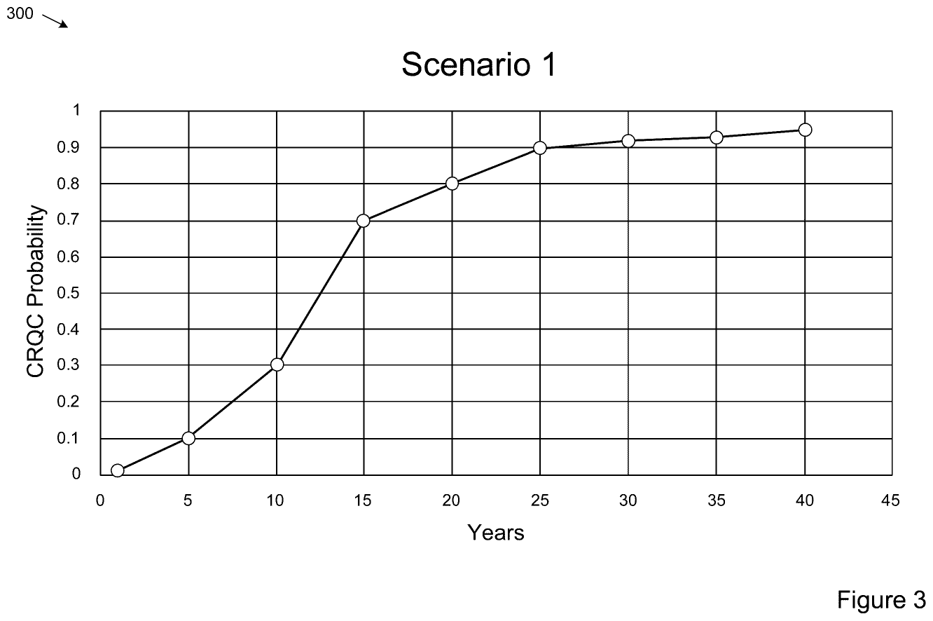

In one example scenario 300 shown in FIG. 3, it is assumed there is a low probability in the short term, with future advances increasing the likelihood of development of CRQCs until the likelihood asymptotes to unity. This is a damped exponential scenario which asymptotes to 1.

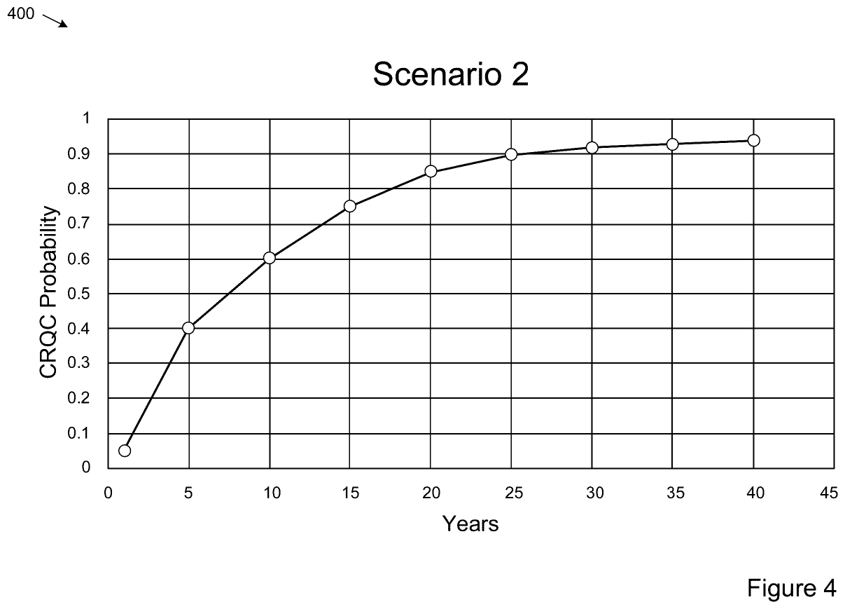

In an alternative example scenario 400 shown in FIG. 4, it is assumed there is a mid-to high-probability of development of CRQCs in the short term, which then also asymptotes to 1. This is a logarithmic scenario.

Over 40 years, the example scenarios 300 and 400 carry the same risks, though the 1-5 year risks are very different between these scenarios. It can be difficult to know which of the scenarios 300 and 400 applies to the current and/or future situations. If experts were consulted, their answers would be biased by their dispositions to the current market. This uncertainty between these two scenarios 300 and 400 means one should either err on the riskier side (Scenario 400) or apply a weighting factor to represent this uncertainty.

Another point of concern is how to quantify the risk of CRQCs when CRQCs do not yet exist. It is not known if CRQCs will be cloud-based or if they will be readily available like traditional computers. It is not known if access will be regulated or monitored in any capacity. It is also not known all the manners that CRQCs can present risks. In this sense, many scenarios can be created on how risky a quantum threat is to an asset, with some of these scenarios being better than others.

This has a lot of similarity in evaluating climate change risk. Climate change is also a very complex, highly-coupled system which is exposed to external forcing. It is known that there are risks, but it is not known how big the risks are nor when they will take effect.

An example risk score described herein follows the risk scoring in the Crypto Agility Risk Assessment Framework (CARAF), where the risk is defined as: risk=cost*timeline. The present model uses the following five different data tables stored in the database 120.

Applications: Applications are data sources which carry some financial impact for the relevant entity (e.g., a financial institution).

TABLE
application

| | | Calc, | | |
|---|---|---|---|---|
| | | Filter, | Data | Default |
| Attribute Name | Description | Context | Type | Value |
| application_id | ID associated with | calc | int | NAN |
| | application | | | |
| application_desc | Description of | context | str | empty |
| | application | | | |
| financial_impact | annual financial impact | calc | float | NAN |
| | if application is | | | |
| | compromised | | | |
| impact | CAT risk category from | filter | str | NAN |
| | score range | | | |
| line_of_business | division within the | filter | str | NAN |
| | entity that owns the | | | |
| | application | | | |
| Shelf life | remaining years app | calc | int | NAN |
| | will be in use | | | |
| aff_node_models | list of node_model_ids | calc | list | empty |
| | affiliated with the app | | | |

Nodes: Nodes are points in the data flow path which have either a cryptographic profile or a point of attack from a bad actor.

TABLE
node

| | | Calc, | | |
|---|---|---|---|---|
| | | Filter, | Data | Default |
| Attribute Name | Description | Context | Type | Value |
| node_model_id | id of the node model | calc | int | NAN |
| node_desc | description of node | context | | empty |
| | and node function | | | |
| num_instances | number of node_ids | context | int | empty |
| | affiliated with the | | | |
| | node_model_id | | | |
| individual_node_ids | ids associated with | context | int | NAN |
| | individual node | | | |
| | (serial number) | | | |
| crypto_profile | list of crypto IDs | calc | list | NAN |
| | | | of ints | |
| device_3rd_party | | context | | empty |

Geospatial: Contains data about the geospatial locations of nodes.

TABLE
geospatial

| | | | | Default |
|---|---|---|---|---|
| Attribute Name | Description | Calc, Filter, Context | Data Type | Value |
| coordinates | coordinates | context | coordinates | NAN |
| | of a location | | (or string) | |
| individual_node_ids | list of individual nodes | context | | empty |
| | that are at this location | | | |

Crypto: Contains the cryptographic profiles of nodes and their remediation.

TABLE
crypto

| | | Calc, | | |
|---|---|---|---|---|
| | | Filter, | Data | Default |
| Attribute Name | Description | Context | Type | Value |
| crypto_id | unique id for each | calc | int | NAN |
| | crypto method | | | |
| name | name of method | context | str | empty |
| purpose | cryptographic | context | list of str | NAN |
| | function | | | |
| standards | standards | context | list of str | empty |
| | reference material | | | |
| remediations | list of remediation | calc | list of ints | NAN |
| | method ids | | | |

Remediations: Contains the remediation(s) for a type for cryptography in order to become quantum resilient.

TABLE
remediations

| | | | Data | Default |
|---|---|---|---|---|
| Attribute Name | Description | Calc, Filter, Context | Type | Value |
| remediation_id | unique id for each | calc | int | NAN |
| | remediation method | | | |
| name | name of method | context | str | NAN |
| purpose | cryptographic function | context | list of str | NAN |
| | that is addressed | | | |
| standards | standards reference | context | list of str | empty |
| | material | | | |
| affected_crypto_names | list of crypto names | context | list of str | empty |
| | which are addressed | | | |
| implementation_cost | how many years it will | calc | float | NAN |
| | take to implement | | | |
| | remediation across the | | | |
| | entity (for each | | | |
| | individual node model) | | | |

The risk is considered of data at rest (e.g., stored in some databank) and data in motion (e.g., data which has a flow path through a series of nodes). The quantified risk is that the entity will lose revenue or assets due to a cryptographic attack from CRQCs. But when looking at cryptographic transitions, one cannot just consider the encryption method of the asset itself, as the data is mobile and can be attacked at multiple points. It is desirable to determine which device should have priority for mitigate the highest risks associated with CRQCs.

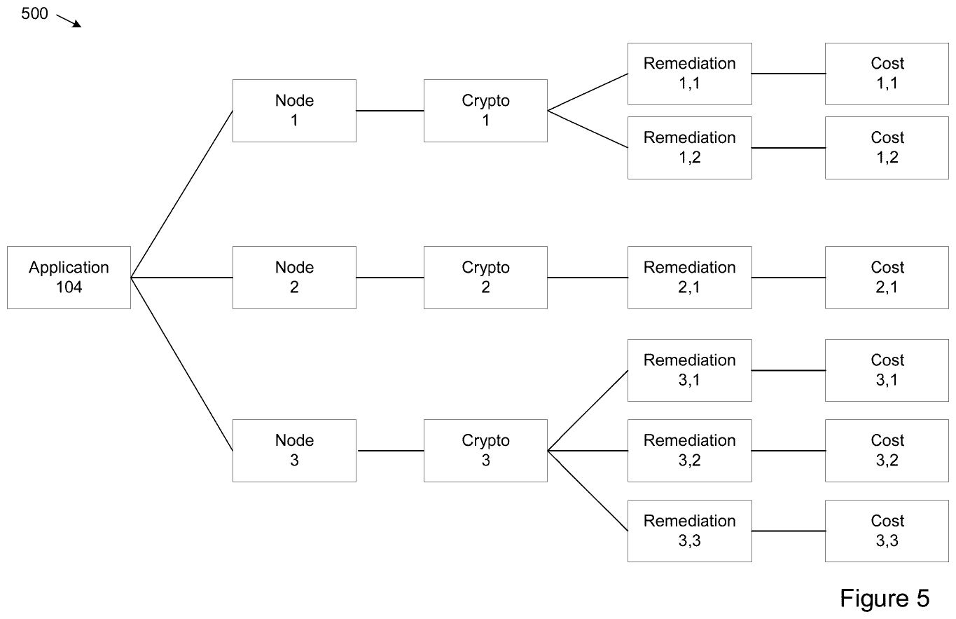

Referring now to an example framework 500 of FIG. 5, the application 104 of the system 100 is depicted, which has data pass through three nodes (1, 2, 3). A single node can have multiple points of cryptogrophy (1, 2, 3), and a single cryptography may have multiple remediations depending on the context of use (e.g., RSA is used for digital signatures and asymmetric keys and each use case may have distinct remidiations).

Examples of possible remediations based upon the type of cryptography are provided in the following table stored in the database 120.

| Name | Purpose | Remediation |
|---|---|---|
| AES | Encryption | Larger Key |
| | | Size |
| SHA-2 | Hash Functions | Larger Output |
| SHA-3 | Hash Functions | Larger Output |
| RSA | Signatures, Public Key Encryption | PQC |
| Diffie-Hellman | Public Key Encryption | PQC |
| ECC | Digital Signatures, Public Key | PQC |
| | agreement, symmetric encryption | |
| DSA Finite Fields | Signatures, Key Exchange | PQC |
| Hardware security | Private key management | |
| module (HSM) | | |

When the application 104 is being modeled, one can call to a separate table or database for that application. For instance, the computing device 102 can make calls to the database 120 to obtain the data necessary to perform the following:
1) For an individual ‘t’ (′t′ is the “Q-Day” for when a PQC becomes a threat)
2) For node [1,n]:
   a. If ‘application_1_shelflife’< ‘t’ then 0
   b. For multiple ‘remediation_cost’ choose lowest
      i. This field can be expanded to encompass implementation strategy.
      ii. Have a list of all available remediations and select exclusions and inclusions
   c. Else, let ‘application_1_node_x_remediation’=‘remediation_cost xx’
3) Choose max: ‘application_1_node_x_remediation’=‘application_1_remediation’
4) Perform: ‘application_1_risk’=‘application_1_annual financial impact’ *‘application_1_remediation’
5) Set: ‘node_x_application_1_risk’=‘application_1_risk’
6) Perform for all applications
7) For a single node perform: ‘node_x_risk’=‘node_x_application_1_risk’+ . . . ‘node_x_application_n_risk’
8) Iterate for all ‘t’ in distribution
9) Perform expectation cost over all ‘t’ for device risk

Since one does not know for certain what “t” is, the model is run many times over a distribution of “t”. A normal distribution is found where:

$$t ( τ ) = \frac{1}{σ \sqrt{2 π}} EXP [ - \frac{1}{2} {( \frac{τ - μ}{σ} )}^{2} ]$$

Here, μ is the mean of the distribution or what is considered to be the most likely date for a CRQC, σ is the standard deviation or how narrow the distribution is, and τ is a dummy variable for a general time. One would also define how many “t” will be run by the model, which is called “N”. One can then calculate the “expected cost” for an asset by performing the following calculation:

$$expected\_cost = {\sum }_{i = 1}^{N} ( \frac{1}{N} * {cost}_{i} )$$

For example, if one runs the model over 100t, the expected cost of asset 1 would be:

$${expected\_cost}_{asset 1} = ( \text{.01} ) {C}_{1} + ( \text{.01} ) {C}_{2} … + ( \text{.01} ) {C}_{100}$$

Or if it is run over 1000t:

$${expected\_cost}_{asset 1} = ( \text{.001} ) {C}_{1} + ( \text{.001} ) {C}_{2} … + ( \text{.001} ) {C}_{1000}$$

This “expected cost” evaluation is done so that one can accurately represent the uncertainty in “t”.

One then iterates over many different distributions to show changes in risk for different estimates in quantum computer development timelines.

This model does not consider the “Harvest Now, Decrypt Later” type risks, where data is obtained and stored, and nefarious decryption efforts are made at a future point in time. Because of this, developing a different relationship between “t”, “shelf life”, and “remediation” may be desired. Consider the following scenarios:

| | | | | Risk Modifier |
|---|---|---|---|---|
| “t” | Shelf life | Remediation | Relationship | (1-8) |
| Soon | Long | Quick | T~R < S | 4 |
| Soon | Short | Quick | T~S~R | 3 |
| Soon | Long | Slow | T < S~R | 8 |
| Soon | Short | Slow | T~S < R | 6 |
| Distant | Long | Quick | R < S~T | 1 |
| Distant | Short | Quick | R~S < T | 2 |
| Distant | Long | Slow | R~S~T | 7 |
| Distant | Short | Slow | S < R~T | 5 |

One would want to evaluate the above scenarios to determine the appropriate risk modifier in a data driven method. From that risk, one can derive a function that models that specific risk modifier.

Another model can be used to consider the “Harvest Now, Decrypt Later” type risks. For instance, assume there is total amount of encrypted data that is harvested which is given by €. The loss rate is then:

$$\frac{d ξ}{dt} = β ( t ) + ϕ ( t ) - δ ( t )$$

Here:
β(t) is the background loss rate. This will be a term which is linear in time.
ϕ(t) is a forcing term. This term would encapsulate all non-background losses. Likely some periodic pulse with high amplitude and low frequency in order to model large, uncommon data harvesting events. One could use a square pulse wave such as:

$$ϕ = \frac{A τ}{T} + \frac{2 A}{π} {\sum }_{n = 1}^{∞} \frac{1}{n} sin ( π n \frac{τ}{T} ) cos ( 2 π n \frac{t}{T} )$$

Here A is the amplitude of the pulse, T is the period, τ is the pulse length. Or one could use a more sophisticated method to avoid the periodic nature and capture the randomness and potential clustering of attacks.
δ(t) is the damping term. This represents all mitigation efforts which slow the flow rate of harvested information. This term can be liner, quadratic, exponential, etc. where each type of function models how different styles of implementation affect harvest now, decrypt later attacks. E.g. exponential is very aggressive, agile, costly implementation and linear is a slow, ineffective, cheap implementation. A constant would represent a “do-nothing” scenario. Efforts would need to be made to translate the business strategy into an algebraic expression.
After integrating the function, the integration adds a constant term which represents all information which has been harvested prior to today's date.

An example model could look like:

$$\frac{d ξ}{dt} = 3 + \frac{10 * 2}{6} + \frac{20}{π} {\sum }_{n = 1}^{∞} \frac{1}{n} sin ( π n \frac{2}{T} ) cos ( 2 π n \frac{t}{6} ) - 3 t$$

### Here:

$$β = 3$$

$$ϕ = \frac{10 * 2}{6} + \frac{20}{π} {\sum }_{n = 1}^{∞} \frac{1}{n} sin ( π n \frac{2}{T} ) cos ( 2 π n \frac{t}{6} )$$

$$δ = 3 t$$

If one integrates this function from today until Q-Day, a total amount of data harvested is obtained. Since the data harvested only presents an impact once Q-Day is reached, one can use a similar framework for a traditional PQC analysis.

Assume the flow equation is marched forward with time steps of dt as the predictive model is run. At each dt, one randomly selects a volume of data equal to the data volume harvested in that dt. The harvested data is then tagged. For all data harvested via background, one selects a flat, random distribution to be tagged. For data breaches, the tagged data is clustered by introducing a constraint that tagged data must have a shared node to all other data. In some examples, some k-number degrees of separation is allowed (e.g., must be two nodes away, etc.).

When Q-Day arrives, all tagged applications (the data that has been harvested) are toggled, which models the decrypt of that scenario. The financial impact of the compromised applications is summed and called the “total loss”. The risk score and loss score are then reported, such as in the graphical interfaces described below.

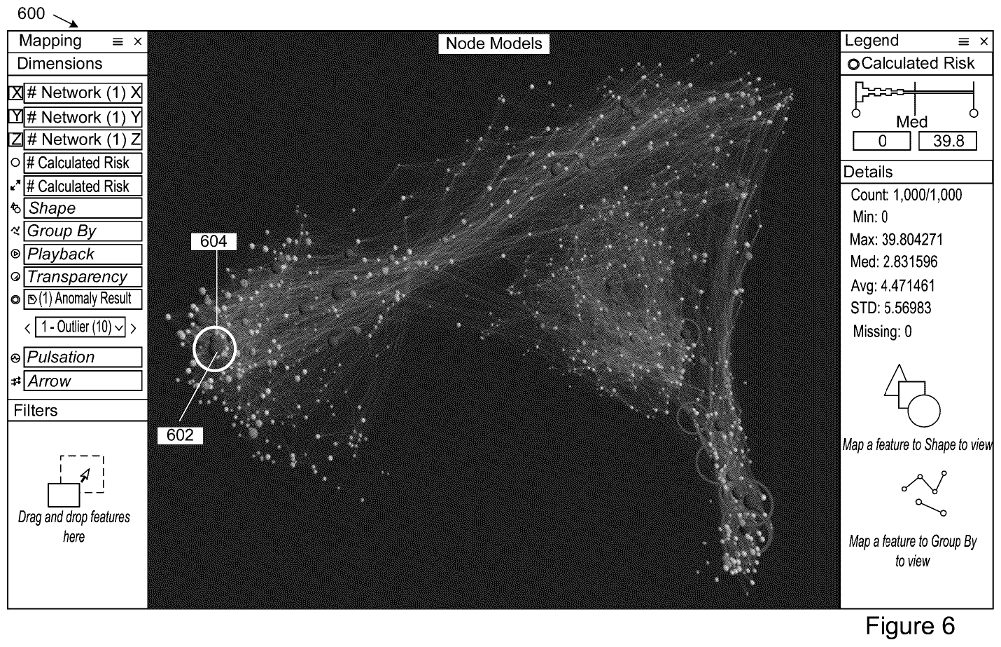

Referring now to FIGS. 6-8, from the model data produced by the computing device 102, it is possible to visually generate graphs that show the risk score rankings of the most at risk assets, show the progression of risk depending on PQC implementation timelines, and/or show the uncertainty and errors in the model.

For example, a network graph 600 is shown in FIG. 6 that illustrates a risk model produced by the computing device 102. In the example graph 600, each point 602 represents a node of an entity being modeled. The color, size/shape and/or other visual cues associated with each point 602 indicates the calculated risk for the node. For instance, the larger the size of each point 602, the larger the risk associated with that application represented by the point. Finally, the riskiest nodes are circled with halos 604 to highlight them.

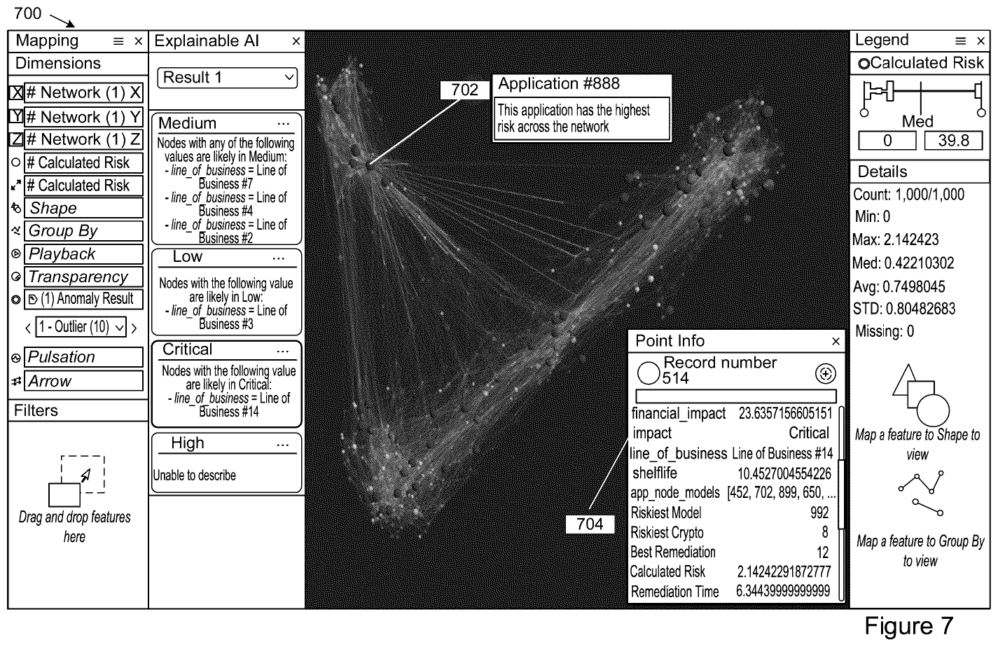

In the example network graph 700 shown in FIG. 7, each point represents an application. A point 702 (“Application #888”) is selected as the application having the highest risk for the entity. Further, an example table 704 provides additional information about the selected point 702, including:
financial impact—an estimated financial impact of the application;
impact—an indicator of the significance of the impact (e.g., critical or minor);
line of business—indication of which business of the entity is impacted;
shelf life—how long the data is relevant (e.g., in years);
best remediation—the best type of remediation, as measured in effectiveness and/or cost;
calculated risk—a quantification of the risk associated with the application; and
remediation time—an estimate on the time necessary to perform remediation.

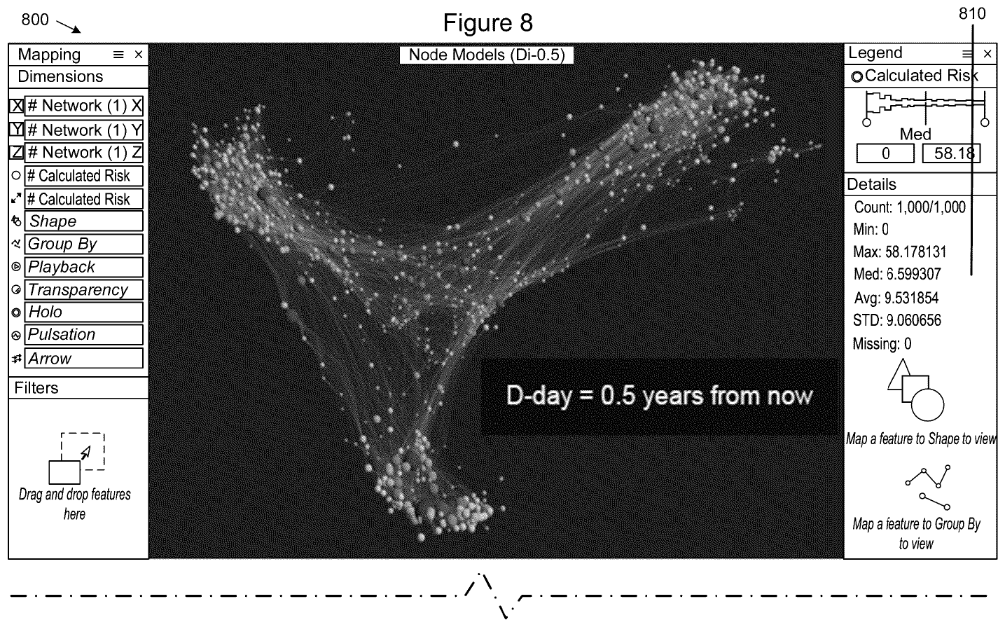

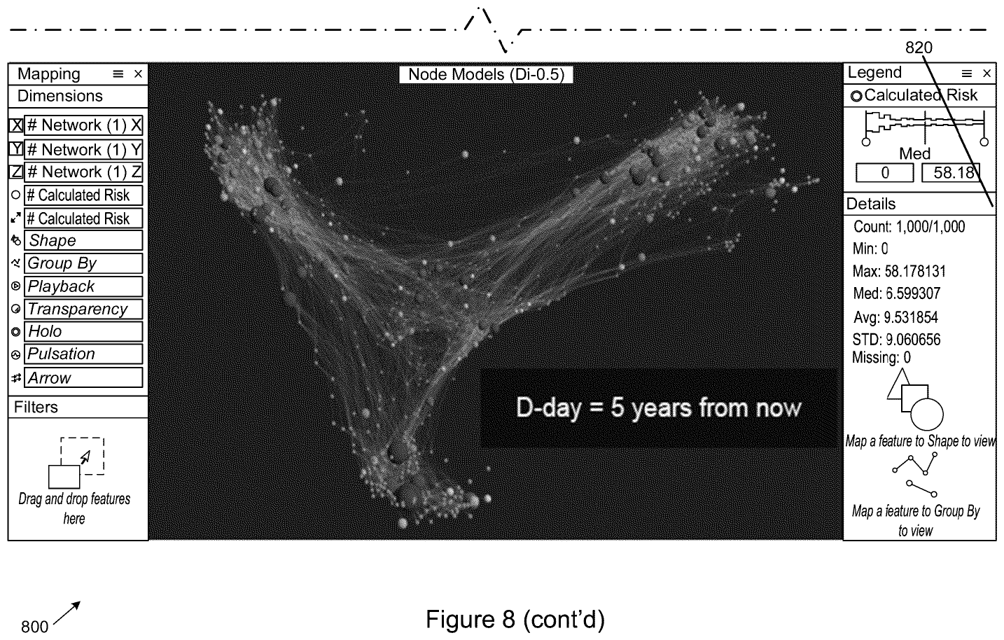

Referring now to FIG. 8, two example network graphs 810, 820 are shown using different Q-Day values. As noted, Q-Day is when a quantum computer becomes a threat.

In this example, the graph 810 illustrates the network when the Q-Day is set at 0.5 years from the present day. Conversely, the graph 820 illustrates the network when the Q-Day is set at 5 years from the present day. The difference in the models shows how the risk changes over time as the assumptions for the models (e.g., the assumed Q-Day) are modified.

Currently, the models may not consider statistical or systematic errors. Each variable will have some internal variance. The shelf life of an asset is likely variable, the annual asset value changes year to year, etc. It is recommend adding in the error analysis on the simple model before expanding the complexity of the model.

There are likely many additional variables that can be added to the model for a more nuanced risk assessment. One should resist adding additional variables before building out the base model. Once the base model is complete, one can more easily incorporate additional components.

There are many advantages associated with the modeling described herein. The modeling helps to forecast the integrity of data into the future, which has the practical application of allowing networks to be more secure. Further, the modeling provides a more efficient manner for selecting particular types of cryptography that further enhance the security of data into the future.

In addition to assessing the risks associated with cryptography, the examples provided herein can be used to assess other risks. For instance, in alternative embodiments, the examples provided herein can be used to assess other risks associated with information technology, such as server risks, perimeter risks, data risks, etc.

One or more computing devices, such as the computing device 102, can be used to analyze the scenarios using the models described herein. Each computing device can include at least one processor and system memory.

The system memory includes a random access memory (“RAM”) and a read-only memory (“ROM”). The computing device further includes a mass storage device. The mass storage device is able to store software instructions and data. The mass storage device and its associated computer-readable data storage media provide non-volatile, non-transitory storage for the computing device.

Computer-readable data storage media can be any available non-transitory, physical device or article of manufacture. Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device.

The mass storage device and the RAM of the computing device can store software instructions and data. The software instructions include an operating system suitable for controlling the operation of the computing device. The mass storage device and/or the RAM also store software instructions and software applications that, when executed by the CPU, cause the computing device to provide the functionality of the computing device discussed in this document. For example, the mass storage device and/or the RAM can store software instructions that, when executed by the CPU, cause computing device to display data on the display screen of the computing device.

Although various embodiments are described herein, those of ordinary skill in the art will understand that many modifications may be made thereto within the scope of the present disclosure. Accordingly, it is not intended that the scope of the disclosure in any way be limited by the examples provided.

1. A system for modeling of risk associated with post-quantum cryptography, the system comprising:
at least one processor; and
memory encoding instructions that, when executed by the at least one processor, cause the system to:
identify a plurality of applications associated with an entity, with the plurality of applications including one or more nodes;
define one or more cryptographies used by the one or more nodes associated with the plurality of applications;
determine a plurality of remediations for the one or more cryptographies;
select an estimated time at which the one or more cryptographies will be compromised by the post-quantum cryptography;
estimate a cost of remediation for the plurality of remediations for one or more of the plurality of applications;
calculate a risk based on the cost of remediation and the estimated time; and
select an at-risk node of the one or more nodes with a highest risk.

2. The system of claim 1, wherein the plurality of applications is used by the entity to conduct business.

3. The system of claim 2, comprising further instructions that, when executed by the at least one processor, cause the system to:
identify: (i) a financial impact score defining an annual financial impact when each of the plurality of applications is compromised; and (ii) a shelf life defining how long each of the plurality of applications will be used; and
use the financial impact score and the shelf life to estimate the cost of remediation.

4. The system of claim 1, wherein the one or more cryptographies include one or more cryptographic methods used to secure each of the plurality of applications.

5. The system of claim 1, wherein the estimated time is a number of years until a cryptographically-relevant quantum computer is developed.

6. The system of claim 1, comprising further instructions that, when executed by the at least one processor, cause the system to estimate the cost of remediation over a distribution of different estimated times at which the one or more cryptographies will be compromised.

7. The system of claim 1, comprising further instructions that, when executed by the at least one processor, cause the system to model risks associated with harvesting data now and decryption of the data at a later point.

8. The system of claim 1, comprising further instructions that, when executed by the at least one processor, cause the system to generate a graph depicting the modeling of the risk.

9. The system of claim 8, wherein the graph includes a point representing each of the plurality of applications, wherein a size of the point indicates a relative impact of an application associated with the point.

10. The system of claim 9, comprising further instructions that, when executed by the at least one processor, cause the system to generate a table upon receipt of selection of the point, wherein the table includes: (i) an estimate of financial impact; and (ii) an estimate of time to perform remediation.

11. A method for modeling of risk associated with post-quantum cryptography, the method comprising:
identifying, by a computing device, a plurality of applications associated with an entity, with the plurality of application including one or more nodes;
defining one or more cryptographies used by the one or more nodes;
determining, by the computing device a plurality of remediations for the one or more cryptographies;
selecting an estimated time at which the one or more cryptographies will be compromised by the post-quantum cryptography;
estimating, by the computing device, a cost for the plurality of remediations for one or more of the plurality of applications
calculating, by the computing device, a risk based on the cost of remediation and the estimated time; and
selecting an at-risk node of the one or more nodes with the highest risk.

12. The method of claim 11, wherein the plurality of applications is used by the entity to conduct business.

13. The method of claim 12, further comprising:
identifying: (i) a financial impact score defining an annual financial impact when each of the plurality of applications is compromised; and (ii) a shelf life defining how long each of the plurality of applications will be used; and
using the financial impact score and the shelf life to estimate the cost of remediation.

14. The method of claim 11, wherein the one or more cryptographies include one or more cryptographic methods used to secure each of the plurality of applications.

15. The method of claim 11, wherein the estimated time is a number of years until a cryptographically-relevant quantum computer is developed.

16. The method of claim 11, further comprising estimating the cost of remediation over a distribution of different estimated times at which the one or more cryptographies will be compromised.

17. The method of claim 11, further comprising modeling risks associated with harvesting data now and decryption of the data at a later point.

18. The method of claim 11, further comprising generating a graph depicting the modeling of the risk.

19. The method of claim 18, wherein the graph includes a point representing each of the plurality of applications, wherein a size of the point indicates a relative impact of an application associated with the point.

20. The method of claim 19, further comprising generating a table upon receipt of selection of the point, wherein the table includes: (i) an estimate of financial impact; and (ii) an estimate of time to perform remediation.
